(19) United States
(12) Patent Application Publication
(10) Pub. No.: US 2025/0043125 A1
(43) Pub. Date: Feb. 6, 2025

(54) Low-Fluidity Polymer Composition Including Acrylonitrile-Butadiene-Styrene Copolymer and Terpolymer and Method of Reducing Fluidity of Acrylonitrile-Butadiene-Styrene Copolymer

(71) Applicant: SK Geo Centric Co., Ltd., Seoul (KR)

(72) Inventors: Guillaume Jacques, Serquigny (FR); Elisabeth Loerch, Barc (FR)

(21) Appl. No.: 18/717,648

(22) PCT Filed: Nov. 25, 2022
(86) PCT No.: PCT/KR2022/018804

§ 371 Date: Jun. 7, 2024

(30) Foreign Application Priority Data
Dec. 9, 2021 (FR) FR2113244

(51) Int. Cl. C08L 55/02; B29C 48/00; B29C 48/07; B29C 48/36; B29K 55/02

(52) U.S. Cl. CPC C08L 55/02; B29C 48/022; B29C 48/07; B29C 48/36; B29K 2023/06; B29K 2055/02; B29K 2995/0012; B29K 2995/0089; C08L 2205/03

(57) ABSTRACT

Provided are a low-fluidity polymer composition including an acrylonitrile-butadiene-styrene copolymer and a terpolymer, and a method of reducing fluidity of an acrylonitrile-butadiene-styrene copolymer. When the low-fluidity polymer composition is used, it is easy to adjust the viscosity of the composition, workability in a polymer processing step is improved, and an article having excellent impact strength may be manufactured in various shapes.

### CROSS-REFERENCE TO RELATED APPLICATIONS

This application is the United States national phase of International Patent Application No. PCT/KR2022/018804 filed Nov. 25, 2022, and claims priority to French Patent Application No. FR2113244 filed, Dec. 9, 2021, the disclosures of each of which are hereby incorporated by reference in their entireties.

### BACKGROUND

### 1. Technical Field

The following disclosure relates to a low-fluidity polymer composition including an acrylonitrile-butadiene-styrene copolymer and a terpolymer and a method of reducing fluidity of an acrylonitrile-butadiene-styrene copolymer.

### 2. Technical Considerations

An acrylonitrile-butadiene-styrene (ABS) copolymer has advantages such as excellent chemical resistance, dimensional stability, processability, and the like, and is used in a wide variety of fields such as washing machines, TVs, refrigerators, monitors, copiers, fax machines, car side mirrors, mobile phone cases, toy materials, and game consoles.

There are various processing methods of an ABS copolymer, and the above listed products may be manufactured mainly by injection molding. One of the important things in the processing step is a melt flow index (MFI) which refers to a viscosity of a molten polymer, and a polymer composition having a high melt flow index, that is, having high fluidity, is mainly used in the injection molding.

Meanwhile, since interest in environmental friendliness is increased, a demand for plastic recycling is rising, and also, a lot of research and development for ABS recycling are being conducted. However, when the ABS copolymer is recycled, impact strength is decreased, and in particular, when an injection processed article is recycled, the melt flow index is significantly high, so that other processing methods such as sheet and profile extrusion may not be used.

In addition, since the ABS copolymer has insufficient impact strength itself as compared with other thermoplastic polymers, an impact modifier and the like may be added to improve the impact strength of the ABS copolymer. However, when the additive is added, viscosity is decreased and the melt flow index is increased, and thus, there is still a problem in that workability is deteriorated in extrusion processing and the quality of the manufactured article is deteriorated.

Therefore, there is a demand for research and development for a polymer composition having improved impact strength and also decreased fluidity to have a melt flow index being advantageous for extrusion processing.

### SUMMARY

A non-limiting embodiment of the present disclosure is directed to providing a low-fluidity polymer composition including an acrylonitrile-butadiene-styrene copolymer and a terpolymer.

Another non-limiting embodiment of the present disclosure is directed to providing a polymer composition which is appropriate for a processing method requiring a low melt flow index such as sheet or profile extrusion by including a terpolymer in an acrylonitrile-butadiene-styrene copolymer to impart low fluidity to the polymer composition. Still another non-limiting embodiment of the present disclosure is directed to providing a high-quality article having improved processability, and improved impact strength.

In order to solve the above problems, it has been found that when a polymer composition includes an acrylonitrile-butadiene-styrene copolymer and a terpolymer including a first repeating unit derived from ethylene and a second repeating unit including a glycidyl group, the melt flow index of the polymer composition is effectively decreased, and also, an article having improved impact strength may be manufactured using the polymer composition, thereby completing the present disclosure.

In one general non-limiting aspect, a low-fluidity polymer composition includes: an acrylonitrile-butadiene-styrene (ABS) copolymer and a terpolymer, wherein the terpolymer includes a first repeating unit derived from ethylene and a second repeating unit including a glycidyl group.

According to an exemplary and non-limiting embodiment of the present disclosure, the terpolymer may include a second repeating unit derived from glycidyl (meth)acrylate and a third repeating unit derived from methyl (meth)acrylate.

According to an exemplary and non-limiting embodiment of the present disclosure, the second repeating unit may include 3 to 20 wt % of the terpolymer, based on the total weight.

According to an exemplary and non-limiting embodiment of the present disclosure, the third repeating unit may include 20 to 30 wt % of the terpolymer, based on the total weight.

According to an exemplary and non-limiting embodiment of the present disclosure, the terpolymer may be included at 0.1 to 10 wt %, based on the total weight of the composition.

According to an exemplary and non-limiting embodiment of the present disclosure, the polymer composition may further include a copolymer including a repeating unit derived from methyl (meth)acrylate and a repeating unit derived from ethylene.

According to an exemplary and non-limiting embodiment of the present disclosure, the copolymer may be included at 1 to 20 wt %, based on the total weight of the composition.

According to an exemplary and non-limiting embodiment of the present disclosure, the low-fluidity polymer composition may satisfy the following Equation 1:

$${MFI}_{COM} / {MFI}_{ABS} < 1.0 \qquad [ Equation 1 ]$$

wherein MFI_{COM} is a melt flow index (g/10 min.) of the low-fluidity polymer composition, MFI_{ABS} is a melt flow index of a pure ABS copolymer, and the melt flow index is measured in accordance with ISO 1133-1 (2011).

According to an exemplary and non-limiting embodiment of the present disclosure, the low-fluidity polymer composition may be for extrusion processing.

According to an exemplary and non-limiting embodiment of the present disclosure, the low-fluidity polymer composition may not substantially include polycarbonate.

According to an exemplary and non-limiting embodiment of the present disclosure, an article manufactured by processing the low-fluidity polymer composition may satisfy the following Equation 2:

$${IS}_{COM} / {IS}_{ABS} > 1. \qquad [ Equation 2 ]$$

wherein IS_{COM} is an impact strength (kJ/m²) of an article manufactured by processing the low-fluidity polymer composition, IS_{ABS} is an impact strength of an article manufactured by processing a pure ABS copolymer, and the impact strength is measured in accordance with ISO 179 1eA.

In another general non-limiting aspect, an article manufactured by processing the low-fluidity polymer composition described above may be provided.

In still another general non-limiting aspect, a method of reducing fluidity of an ABS copolymer includes: melt-mixing (melt-extrusion) a polymer composition including an acrylonitrile-butadiene-styrene (ABS) copolymer and a terpolymer by an extruder, wherein the terpolymer includes a first repeating unit derived from ethylene and a second repeating unit including a glycidyl group.

Other features and non-limiting aspects will be apparent from the following detailed description, the drawings, and the claims.

### DETAILED DESCRIPTION

The present disclosure may provide a low-fluidity polymer composition including an acrylonitrile-butadiene-styrene copolymer and a terpolymer. Specifically, the low-fluidity polymer composition may impart an advantageous melt flow index in extrusion processing requiring low fluidity by an interaction of the terpolymer and the acrylonitrile-butadiene-styrene copolymer, and also, an article having improved impact strength may be manufactured using the composition. Accordingly, when the low-fluidity polymer composition is used, it is easy to adjust the viscosity of the composition, workability in a polymer processing step is improved, and an article having excellent impact strength may be manufactured in various shapes.

Hereinafter, the present disclosure will be described in more detail. However, the following examples or embodiments are only a reference for describing the present disclosure in detail, and the present disclosure is not limited thereto and may be implemented in various shapes.

In addition, unless otherwise defined, all technical terms and scientific terms have the same meanings as those commonly understood by one of those skilled in the art to which the present disclosure pertains.

The terms used herein are only for effectively describing a certain embodiment, and are not intended to limit the present disclosure.

In addition, the singular form used in the specification and claims appended thereto may be intended to also include a plural form, unless otherwise indicated in the context.

In addition, unless particularly described to the contrary, “comprising” any elements will be understood to imply further inclusion of other elements rather than the exclusion of any other elements.

In addition, the numerical range used in the present specification may include all values within the range including the lower limit and the upper limit, increments logically derived in a form and span in a defined range, all double limited values, and all possible combinations of the upper limit and the lower limit in the numerical range defined in different forms. Unless otherwise defined in the specification of the present disclosure, values which may be outside a numerical range due to experimental error or rounding of a value are also included in the defined numerical range.

“Low fluidity” described in the present disclosure refers to a characteristic having a melt flow index lower than a melt flow index of a base polymer in a polymer composition. Specifically, a polymer composition having the melt flow index lower than the melt flow index of an acrylonitrile-butadiene-styrene copolymer may be defined as a low-fluidity polymer composition.

The meaning of “does not substantially include” described in the present disclosure may be including 1 part by weight or less, specifically 0.1 parts by weight or less, based on 100 parts by weight of the acrylonitrile-butadiene-styrene (ABS) copolymer. For example, the meaning of a low-fluidity polymer composition that “does not substantially include polycarbonate or a polymer containing maleic anhydride functional group” may be including 1 part by weight or less, specifically 0.1 part by weight or less of polycarbonate or a polymer containing maleic anhydride functional group, based on 100 parts by weight of the acrylonitrile-butadiene-styrene (ABS) copolymer.

The present disclosure provides a low-fluidity polymer composition including: an acrylonitrile-butadiene-styrene (ABS) copolymer and a terpolymer, wherein the terpolymer includes a first repeating unit derived from ethylene and a second repeating unit including a glycidyl group.

The acrylonitrile-butadiene-styrene copolymer (hereinafter, referred to as ABS copolymer) may be an acrylonitrile-butadiene-styrene copolymer in which butadiene, styrene, and acrylonitrile are polymerized by a common or known method. For example, it may be a polymer polymerized by an emulsion polymerization method or suspension polymerization method, and a commercially available product may be used without limitation.

As a non-limiting example, a repeating unit derived from butadiene may be included at 5 to 50 wt %, specifically 20 to 40 wt %, a repeating unit derived from styrene may be included at 20 to 70 wt %, specifically 25 to 60 wt %, and a repeating unit derived from acrylonitrile may be included at 5 to 40 wt %, specifically 10 to 35 wt %, based on the total weight of the ABS copolymer. The weight average molecular weight (Mw) of the ABS copolymer may be 10,000 to 500,000 g/mol, 50,000 to 300,000 g/mol, or 80,000 to 250,000 g/mol. In addition, the glass transition temperature (Tg) of the ABS copolymer may be 70 to 150° C. or 80 to 130° C., and a melting temperature (Tm) of the ABS copolymer may be 150 to 300° C. or 180 to 250° C. The melt flow index (MFI) of the ABS copolymer may be 1 to 100 g/10 min., 1 to 50 g/10 min., or 5 to 30 g/10 min., but is not limited thereto.

According to an exemplary and non-limiting embodiment, the terpolymer may include a first repeating unit derived from ethylene, a second repeating unit derived from glycidyl (meth)acrylate, and a third repeating unit derived from methyl (meth)acrylate. Specifically, the terpolymer may include a first repeating unit derived from ethylene, a second repeating unit derived from glycidyl methacrylate, and a third repeating unit derived from methyl acrylate.

The terpolymer may be a terpolymer in which ethylene, glycidyl (meth)acrylate, and methyl (meth)acrylate are polymerized by a common or known method, or a commercially available product may be used without limitation.

Specifically, the second repeating unit may be included at 0.1 to 50 wt %, specifically 1 to 30 wt %, and more specifically 3 to 20 wt %, based on the total weight of the terpolymer. In addition, the third repeating unit may be included at 0.1 to 50 wt %, specifically 5 to 40 wt %, and more specifically 20 to 30 wt %, based on the total weight of the terpolymer. The weight average molecular weight (Mw) of the terpolymer may be 10,000 to 500,000 g/mol or 50,000 to 250,000 g/mol, and the melt flow index (MFI, 190° C./2.16 kg) of the terpolymer may be 1 to 100 g/10 min., 1 to 40 g/10 min., or 1 to 30 g/10 min., but are not limited thereto. The polymer composition including the terpolymer satisfying the above ranges has an effectively decreased melt flow index (MFI) to improve workability in extrusion processing and also improve impact strength of the manufactured article.

According to an exemplary and non-limiting embodiment, the terpolymer may be included at 0.1 to 20 wt % or 0.1 to 10 wt %, specifically 0.5 to 7 wt %, and more specifically 1 to 5 wt %, based on the total weight of the composition. When the above ranges are satisfied, the melt flow index (MFI) of the polymer composition may be adjusted more easily, and an article having further improved impact strength may be manufactured. In addition, the content of the terpolymer may be appropriately adjusted to easily implement the melt flow index (MFI) of the polymer composition to be targeted and the impact strength of the manufactured article.

According to an exemplary and non-limiting embodiment, the polymer composition may further include a copolymer including a repeating unit derived from methyl (meth)acrylate and a repeating unit derived from ethylene. Specifically, a copolymer in which methyl (meth)acrylate and ethylene are polymerized by a common or known method may be used or a commercially available product may be used without limitation. Specifically, the copolymer may be poly(ethylene-co-methyl methacrylate) or poly(ethylene-co-methyl acrylate).

As a non-limiting example, the repeating unit derived from methyl (meth)acrylate may be included at 1 to 50 wt %, specifically 15 to 35 wt %, and the repeating unit derived from ethylene may be included at 50 to 99 wt %, specifically 65 to 85 wt %, based on the total weight of the copolymer. The weight average molecular weight (Mw) of the copolymer may be 10,000 to 500,000 g/mol or 50,000 to 250,000 g/mol and the melt flow index (MFI, 190° C./2.16 kg) of the copolymer may be 1 to 800 g/10 min., 1 to 50 g/10 min., or 1 to 45 g/10 min., but are not limited thereto.

The copolymer may be included at 0.1 to 30 wt %, 1 to 20 wt %, or 1 to 15 wt %, based on the total weight of the composition. The weight ratio between the terpolymer and the copolymer may be 1:0.1 to 50 or 1:0.5 to 10, but is not limited thereto. In addition, the polymer composition may easily implement the melt flow index (MFI) of the polymer composition to be targeted and the impact strength of the manufactured article by appropriately adjusting the content of the copolymer.

According to an exemplary and non-limiting embodiment, the low-fluidity polymer composition may further include a thermoplastic polymer in addition to the acrylonitrile-butadiene-styrene polymer. The non-limiting example of the thermoplastic polymer may be one or a mixture thereof selected from the group consisting of polyvinyl chloride (PVC), polypropylene (PP), polyacrylate, polyethylene terephthalate (PET), polybutylene terephthalate (PBT), polymethylmethacrylate (PMMA), polyamide, a styrene-acrylonitrile copolymer (SAN), acrylonitrile-styrene-acrylate (ASA), and the like. The thermoplastic polymer may be included at 0.1 to 100 parts by weight, 1 to 50 parts by weight, or 1 to 25 parts by weight, based on 100 parts by weight of the ABS copolymer, but is not limited thereto, and for manufacturing an article having physical properties to be targeted, the content of the composition may be adjusted.

According to an exemplary and non-limiting embodiment, the low-fluidity polymer composition may not substantially include polycarbonate. In case that polycarbonate (PC) is included in the polymer composition, the viscosity of the polymer composition is rather significantly decreased so that it may be difficult to easily implement low fluidity, which may be thus not preferred.

According to an exemplary and non-limiting embodiment, the low-fluidity polymer composition may not substantially include a polymer containing maleic anhydride functional group. In case that the polymer containing maleic anhydride functional group is included in the polymer composition, it may be difficult to implement the viscosity (fluidity) which is desirable in the present disclosure.

According to an exemplary and non-limiting embodiment, the low-fluidity polymer composition may further include an additive which is commonly used in the art, depending on the purpose and the use. For example, a UV stabilizer, a UV absorber, an antioxidant, a viscosity modifier, a plasticizer, a thermal stabilizer, a dye, a pigment, a colorant, a mold release agent, an antistatic agent, an antibacterial agent, a processing aid, a metal deactivator, a flame retardant, an anti-friction agent, a wear resistant agent, a lubricant, and the like may be further included. Here, the additives may be included at an appropriate content within the range which does not impair the physical properties to be desired in the present disclosure.

According to an exemplary and non-limiting embodiment of the present disclosure, the low-fluidity polymer composition may satisfy the following Equation 1, and specifically the following Equation 3:

$${MFI}_{COM} / {MFI}_{ABS} < 1.0 \qquad [ Equation 1 ]$$

$${MFI}_{COM} / {MFI}_{ABS} \leq 0.8 \qquad [ Equation 3 ]$$

wherein MFI_{COM} is a melt flow index (g/10 min.) of the polymer composition, MFI_{ABS} is a melt flow index of a pure ABS copolymer, and the melt flow index is measured in accordance with ISO 1133-1 (2011).

When Equation 1, specifically Equation 3, is satisfied, the polymer composition may have low fluidity, and the polymer composition may have a more advantageous melt flow index to improve workability by extrusion processing.

The present disclosure may provide an article manufactured by processing the low-fluidity polymer composition described above. Any method of processing the article may be used without much limitation as long as it is commonly used or known in the art, and for example, a method such as injection, extrusion, profile extrusion, calendering, and direct blow molding may be used, and in particular, since the low-fluidity polymer composition includes the ABS copolymer and the terpolymer described above, the composition has a decreased melt flow index (MFI), and thus, when the low-fluidity polymer composition is used for extrusion, workability may further improved, and a high-quality article may be manufactured.

According to an exemplary and non-limiting embodiment of the present disclosure, the article manufactured by processing the low-fluidity polymer composition may satisfy the following Equation 2, specifically the following Equation 4. The article may include known articles such as a film and a sheet without limitation. Specifically, the article of the following Equations 2 and 4 may be a sheet:

$${IS}_{COM} / {IS}_{ABS} > 1. \qquad [ Equation 2 ]$$

$${IS}_{COM} / {IS}_{ABS} \leq 1.2 \qquad [ Equation 4 ]$$

wherein IS_{COM} is an impact strength (kJ/m²) of an article manufactured by processing the low-fluidity polymer composition and IS_{ABS} is an impact strength of an article manufactured by processing a pure ABS copolymer, and the impact strength is measured in accordance with ISO 179 1eA.

Since the low-fluidity polymer composition includes the ABS copolymer and the terpolymer described above, the article manufactured using the composition may satisfy Equation 2, specifically Equation 4 to implement excellent impact strength.

More specifically, the low-fluidity polymer composition may satisfy both Equations 1 and 2, specifically both Equations 3 and 4. In this case, the low-fluidity polymer composition having a decreased melt flow index (MFI) may be used to manufacture an article having further improved impact strength.

The present disclosure may provide a method of reducing fluidity of an ABS copolymer including: melt-mixing a polymer composition including an acrylonitrile-butadiene-styrene (ABS) copolymer and a terpolymer by an extruder, wherein the terpolymer includes a first repeating unit derived from ethylene and a second repeating unit including a glycidyl group.

Detailed descriptions for the acrylonitrile-butadiene-styrene (ABS) copolymer and the terpolymer are as described above, and thus, will be omitted.

The method of reducing fluidity of an ABS copolymer may be performed for imparting more advantageous viscosity conditions in the ABS processing step, and specifically, the method of reducing fluidity of an ABS copolymer may be used for obtaining a decreased melt flow index in the ABS extrusion processing.

According to an exemplary and non-limiting embodiment, the method of reducing fluidity of an ABS copolymer may include a step of melt-mixing the polymer composition by an extruder. Any melt-mixing process may be used without much limitation as long as it is a common method of melt-mixing a thermoplastic resin, and as a non-limiting example thereof, the melt-mixing process may be performed at a temperature of 200 to 260° C. using a twin-screw melt-mixing extruder, but is not limited thereto. Then, the polymer composition is melt-mixed to produce pellets for processing by an extruder, and the produced pellets for processing may be used to manufacture an article, but the present disclosure is not limited thereto.

According to an exemplary and non-limiting embodiment, the polymer composition may include both the ABS copolymer and the terpolymer to easily implement low fluidity, thereby being applied to a processing method requiring low fluidity such as extrusion processing to have improved workability, and an article having improved impact strength and high quality may be manufactured.

Hereinafter, the present disclosure will be described in more detail with reference to the examples and the comparative examples. However, the following examples and comparative examples are only an example for describing the present disclosure in more detail, and do not limit the present disclosure in any way.

The physical properties of the following examples and comparative examples of the present disclosure were measured by the following methods.

### [Method of Evaluating Physical Properties]

1. Melt Flow Index (MFI) [g/10 min.]

A melt flow index (MFI) was measured at a temperature of 220° C. under the conditions of a loading of 10 kg in accordance with ISO 1133-1 (2011). The measured values are listed in Table 1, and when the measured MFI value satisfied Equation 1, the composition was determined to have low fluidity.

$${MFI}_{COM} / {MFI}_{ABS} < 1.0 \qquad [ Equation 1 ]$$

wherein MFI_{COM} is a melt flow index of a polymer composition according to the examples and the comparative examples, and MFI_{ABS} is a melt flow index of a pure ABS copolymer.
   2. Impact Strength [kJ/m²]

Notched Charpy Impact strength was measured in accordance with ISO 179 1eA. The measured values are listed in Table 1.

### 3. Flexural Modulus [MPa]

Flexural modulus was measured in accordance with ISO 178. The measured values are listed in Table 1.

### Examples 1 to 5, and Comparative Examples 1 and 2

An acrylonitrile-butadiene-styrene copolymer (Terluran GP22), an ethylene-methylacrylate-glycidylmethacrylate terpolymer (Lotader AX8900), and an ethylene-methylacrylate copolymer (Lotryl 29MA03T) were mixed according to the content ratio of raw materials described in the following Table 1 to prepare polymer compositions. Specifically, the raw materials listed in Table 1 were dry mixed and continuously quantitatively introduced to a supply unit of a twin-screw extruder to perform melt-mixing and produced pellets for processing. The produced pellets were sufficiently dried, and a specimen appropriate for the specification described in the [Method of evaluating physical properties] was prepared to measure the physical properties.

TABLE 1

| | Polymer composition (wt %) | | | | | |
|---|---|---|---|---|---|---|
| | Terluran | Lotader | Lotryl | | Impact | Flexural |
| | GP22 | AX8900 | 29MA03T | MFI | strength | modulus |
| Example 1 | 99 | 1 | — | 9.9 | 24 | 2041 |
| Example 2 | 97 | 3 | — | 7.2 | 27 | 1984 |
| Example 3 | 95 | 5 | — | 6.8 | 30 | 1910 |
| Example 4 | 94 | 1 | 5 | 10.6 | 31 | 1839 |
| Example 5 | 94 | 3 | 3 | 7.9 | 29 | 1784 |
| Comparative | 100 | — | — | 14.2 | 22 | 2171 |
| Example 1 | | | | | | |
| Comparative | 95 | — | 5 | 16 | 37 | 1975 |
| Example 2 | | | | | | |

As seen in Table 1 above, when Comparative Example 1 for a pure ABS copolymer and Examples 1 to 3 for a polymer composition including the ABS copolymer and the terpolymer described above are compared, it was confirmed that MFI of the examples was effectively decreased, and also improved impact strength was shown.

When Example 3 and Comparative Example 2 including the methylacrylate-ethylene copolymer are compared, they had the same amount of ABS copolymer, but their MFIs were conflicting, and as the content of the terpolymer was increased in Examples 1 to 3, MFI was further decreased. Thus, it was confirmed that the polymer composition according to an exemplary and non-limiting embodiment of the present disclosure may effectively implement low fluidity by including the ABS copolymer and the terpolymer.

Hereinabove, although the present disclosure has been described by specified matters and specific exemplary and non-limiting embodiments, they have been provided only for assisting in the entire understanding of the present disclosure. Therefore, the present disclosure is not limited to the exemplary and non-limiting embodiments by the specific matters, and various modifications and changes may be made by those skilled in the art to which the present disclosure pertains from this description.

Therefore, the spirit of the present disclosure should not be limited to the above-described exemplary and non-limiting embodiments, and the following claims as well as all modified equally or equivalently to the claims are intended to fall within the scope and spirit of the disclosure.

1. A low-fluidity polymer composition comprising: an acrylonitrile-butadiene-styrene (ABS) copolymer and a terpolymer, wherein the terpolymer comprises a first repeating unit derived from ethylene and a second repeating unit comprising a glycidyl group.

2. The low-fluidity polymer composition of claim 1, wherein the terpolymer comprises a second repeating unit derived from glycidyl (meth)acrylate and a third repeating unit derived from methyl (meth)acrylate.

3. The low-fluidity polymer composition of claim 2, wherein the second repeating unit is comprised at 3 to 20 wt %, based on the total weight of the terpolymer.

4. The low-fluidity polymer composition of claim 2, wherein the third repeating unit is comprised at 20 to 30 wt %, based on a total weight of the terpolymer.

5. The low-fluidity polymer composition of claim 1, wherein the terpolymer is comprised 0.1 to 10 wt %, based on the total weight of the composition.

6. The low-fluidity polymer composition of claim 1, further comprising a copolymer comprising a repeating unit derived from methyl (meth)acrylate and a repeating unit derived from ethylene.

7. The low-fluidity polymer composition of claim 6, wherein the copolymer is comprised at 1 to 20 wt %, based on the total weight of the composition.

8. The low-fluidity polymer composition of claim 1, wherein the low-fluidity polymer composition satisfies the following Equation 1:
$${MFI}_{COM} / {MFI}_{ABS} < 1.0 \qquad [ Equation 1 ]$$
wherein MFI_{COM} is a melt flow index (g/10 min.) of the low-fluidity polymer composition, MFI_{ABS} is a melt flow index of a pure ABS copolymer, and the melt flow index is measured in accordance with ISO 1133-1 (2011).

9. The low-fluidity polymer composition of claim 1, wherein the low-fluidity polymer composition is for extrusion processing.

10. The low-fluidity polymer composition of claim 1, wherein the low-fluidity polymer composition does not substantially comprise polycarbonate.

11. The low-fluidity polymer composition of claim 1, wherein an article manufactured by processing the low-fluidity polymer composition satisfies the following Equation 2:
$${IS}_{COM} / {IS}_{ABS} > 1. \qquad [ Equation 2 ]$$
wherein IS_{COM} is an impact strength (kJ/m²) of an article manufactured by processing the low-fluidity polymer composition, IS_{ABS} is an impact strength of an article manufactured by processing a pure ABS copolymer, and the impact strength is measured in accordance with ISO 179 1eA.

12. An article manufactured prepared by processing the low-fluidity polymer composition of claim 1.

13. A method of reducing fluidity of an acrylonitrile-butadiene-styrene (ABS) copolymer, the method comprising: melt-mixing a polymer composition comprising ABS copolymer and a terpolymer by an extruder,
wherein the terpolymer comprises a first repeating unit derived from ethylene and a second repeating unit comprising a glycidyl group.

14. The low-fluidity polymer composition of claim 1, wherein the weight average molecular weight (Mw) of the ABS copolymer is 10,000 to 500,000 g/mol.

15. The low-fluidity polymer composition of claim 1, wherein the melt flow index (MFI) of the ABS copolymer is 1 to 100 g/10 min.

16. The low-fluidity polymer composition of claim 1, wherein a weight ratio between the terpolymer and the copolymer is 1:0.1 to 50 or 1:0.5 to 10.

17. The low-fluidity polymer composition of claim 1, wherein the low-fluidity polymer composition further comprises a thermoplastic polymer in addition to the acrylonitrile-butadiene-styrene polymer.

18. The low-fluidity polymer composition of claim 17, wherein the thermoplastic polymer is selected from one or more of polyvinyl chloride (PVC), polypropylene (PP), polyacrylate, polyethylene terephthalate (PET), polybutylene terephthalate (PBT), polymethylmethacrylate (PMMA), polyamide, a styrene-acrylonitrile copolymer (SAN), acrylonitrile-styrene-acrylate (ASA) and/or mixtures thereof.

19. The low-fluidity polymer composition of claim 1, further comprising an additive selected from one or more of a UV stabilizer, a UV absorber, an antioxidant, a viscosity modifier, a plasticizer, a thermal stabilizer, a dye, a pigment, a colorant, a mold release agent, an antistatic agent, an antibacterial agent, a processing aid, a metal deactivator, a flame retardant, an anti-friction agent, a wear resistant, a lubricant, and/or mixtures thereof.

20. The article of manufacture of claim 12, wherein the article is a sheet extrudate or a profile extrudate.
